(19) United States
(12) Patent Application Publication
(10) Pub. No.: US 2017/0070880 A1
(43) Pub. Date: Mar. 9, 2017

(54) METHOD OF PERFORMING AN INITIAL ACCESS BY PROTECTING PRIVACY ON A NETWORK AND USER EQUIPMENT THEREFOR

(71) Applicant: LG ELECTRONICS INC., Seoul (KR)

(72) Inventors: Genebeck HAHN, Seoul (KR); Jaehoon CHUNG, Seoul (KR); Eunjong LEE, Seoul (KR); Jinmin KIM, Seoul (KR); Kukheon CHOI, Seoul (KR); Kwangseok NOH, Seoul (KR)

(73) Assignee: LG ELECTRONICS INC., Seoul (KR)

(21) Appl. No.: 15/307,765

(22) PCT Filed: Feb. 25, 2015
(86) PCT No.: PCT/KR2015/001811

§ 371 Date: Oct. 28, 2016

Related U.S. Application Data
(60) Provisional application No. 62/031,868, filed on Aug. 1, 2014.

(51) Int. Cl. H04W 12/02; H04W 76/02

(52) U.S. Cl. CPC H04W 12/02; H04W 76/021

(57) ABSTRACT

Disclosed is a method for a user equipment to perform an initial access on a network by protecting privacy. The present invention includes the step of performing an RRC (radio resource control) connection setup with the network. And, in the RRC connection setup performing step, the user equipment generates a pseudo permanent identifier for a permanent identifier of the user equipment and sends an RRC connection setup complete message including the pseudo permanent identifier to the network.

### TECHNICAL FIELD

The present invention relates to a wireless communication, and more particularly, to a method for a user equipment to perform an initial access on a network by protecting privacy and user equipment therefor.

### BACKGROUND ART

Location information means a series of informations that can reveal an individual location. Since a multitude of users are provided with various services based on location information of the users through smartphones in LTE/LTE-A environments, the location information is recognized as very sensitive and important information. The privacy issue about location information of a mobile communication user has not been dealt in depth by LTE/LTE-A Specifications led by 3GPP Standardization Organizations until now. The reason for this is that a user equipment authentication system adopted by LTE/LTE-A Specifications succeeds to the user identifier (IMSI) based authentication system employed by the 2^{nd} GSM mobile communication system and the 3^{rd} generation UMTS mobile communication system. In particular, as LTE/LTE-A is an evolved version of 2G/3G Standard, it has the same vulnerability on 2G/3G protocol. This causes the problem of IMSI (international mobile subscriber identity) Privacy corresponding to a user's permanent identifier delivered through an air interface without any protections.

In the 2^{nd} generation GSM mobile communication system or the 3^{rd} generation UMTS mobile communication system, many efforts were made to the studies for providing the privacy protection on user identifiers. Yet, these studies failed to provide any solutions for the privacy issue through a radio interface. Basically, in order to satisfy the requirements for location privacy to some extent, 4G LTE/LTE-A Standard forces a temporary identifier to be used. Although the temporary identifier is defined as an identifier called GUTI (globally unique temporary identifier), it is usable only after the successful completion of user authentication. The GUTI may become a means for identifying a home network of a user desiring an access to a serving network. Yet, if the serving network fails to have any valid credential for the corresponding user, it should verify an identifier of the corresponding user before allowing a specific service to the user. And, such verification is performed by requesting a user's IMSI. In particular, it means that the IMSI is delivered to OTA (Over The Air) without any protections. After the serving network has acquired authentication information on the corresponding user, if the authentication is successfully completed, the serving network delivers the GUTI for the user.

A current LTE/LTE-A system can be mainly divided into a radio access network (RAN) and a core network (CN). The RAN is responsible for all features related to a radio interface and plays a role as an entry point into a network for user equipments. In particular, the RAN provides encryption or integrity protection for all user data and signaling traffic delivered to OTA (Over The Air). Meanwhile, the CN stores subscription informations of users and provides a function of user's user equipment authentication and a function of a security key setup through the stored subscription informations.

LTE/LTE-A provides a data rate of a service level superior to that of 2G or 3G network based on All-IP Core Architecture. Through LTE-A, a radio network structure is being evolved in a manner that small cells (e.g., pico cell, femto cell, etc.) of various types interwork with a macro cell. The object of such trend is to enhance a quality of experience (QoE) in a manner that a macro cell provides a final user with a higher data rate in a situation that multi-layer cells of a basically involved vertical layer coexist. Considering such trend, as numerous small cells are accommodated in 5G wireless communication environment, final users will to be located physically closer to a network. In this case, as user centered connectivity will increase considerably, the importance of user's location information shall increase further.

### TECHNICAL TASKS

One technical task of the present invention is to provide a method for a user equipment to perform an initial access by protecting privacy on a network.

Another technical task of the present invention is to provide a user equipment that performs an initial access by protecting privacy on a network.

Technical tasks obtainable from the present invention are non-limited by the above-mentioned technical task. And, other unmentioned technical tasks can be clearly understood from the following description by those having ordinary skill in the technical field to which the present invention pertains.

### TECHNICAL SOLUTION

To achieve these and other advantages and in accordance with the purpose of the present invention, as embodied and broadly described, a method of performing an initial access by a user equipment in a network by protecting privacy, according to one embodiment of the present invention may include the step of performing an RRC (radio resource control) connection setup with the network, wherein the performing of the RRC connection setup comprises generating a pseudo permanent identifier for a permanent identifier of the user equipment and transmitting an RRC connection setup complete message including the pseudo permanent identifier to the network. The permanent identifier of the user equipment may include IMSI (international mobile subscriber identity). The pseudo permanent identifier may be generated using a bitwise XOR operation with the permanent identifier of the user equipment and a partial value of a long term shared key value shared by the user equipment and a home subscriber server (HSS). The performing of the RRC connection setup may further include the step of transmitting an RRC connection setup request message to the network and the pseudo permanent identifier may be generated using a bitwise XOR operation with the permanent identifier of the user equipment, a partial value of a long term shared key value shared by the user equipment and a home subscriber server (HSS) and a random value used for identification of the user equipment in the RRC connection request message. The random value may include a 40-bit length value and the long term shared key value may include a 128-bit length value.

To further achieve these and other advantages and in accordance with the purpose of the present invention, as embodied and broadly described, a user equipment for performing an initial access in a network by protecting privacy, a user equipment according to another embodiment of the present invention may include a transmitter and a processor for performing an RRC (radio resource control) connection setup with the network, wherein in performing the RRC connection setup, the processor generates a pseudo permanent identifier for a permanent identifier of the user equipment and wherein the processor controls the transmitter to transmit an RRC connection setup complete message including the pseudo permanent identifier to the network. The permanent identifier of the user equipment may include IMSI (international mobile subscriber identity). The processor may generate the pseudo permanent identifier using a bitwise XOR operation with the permanent identifier of the user equipment and a partial value of a long term shared key value shared by the user equipment and a home subscriber server (HSS). In performing the RRC connection setup, the transmitter may transmit an RRC connection setup request message to the network and the processor may generate the pseudo permanent identifier using a bitwise XOR operation with the permanent identifier of the user equipment, a partial value of a long term shared key value shared by the user equipment and a home subscriber server (HSS) and a random value used for identification of the user equipment in the RRC connection request message. The random value may include a 40-bit length value and wherein the long term shared key value comprises a 128-bit length value.

The above-mentioned general description of the present invention and the following details of the present invention are exemplary and may be provided for the additional description of the invention disclosed in claims.

### ADVANTAGEOUS EFFECTS

Accordingly to the method proposed by the present, privacy for a permanent identifier can be efficiently protected in case of an initial aces of a user equipment

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram for a configuration of a base station 105 and a user equipment 110 in a wireless communication system 100.

FIG. 2 is a diagram for one example of a roaming security architecture for a 3GPP network access.

FIG. 3 is a diagram for one example of a procedure for an authentication data exchange between MME and HSS for user authentication.

FIG. 4 is a diagram for one example of an initial access procedure of a user equipment (UE).

FIG. 5 is a diagram of a process for an RRC connection for a user equipment initial access and an attach request message delivery.

FIG. 6 is a diagram of a process for a user equipment (UE) to perform an RRC connection setup.

### BEST MODE FOR INVENTION

Hereinafter, the preferred embodiments of the present invention will be described in detail with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters. For example, although the following description will be made based on the assumption that the mobile communication system is the 3GPP LTE or LTE-A system, the following description may be applied to other mobile communication systems except for particular matters of the 3GPP LTE or LTE-A system.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

Moreover, in the following description, it is assumed that a mobile station refers to a mobile or fixed type user equipment such as a user equipment (UE), an advanced mobile station (AMS) and a machine to machine (M2M) device. Also, it is assumed that the base station refers to a random node of a network terminal, such as Node B, eNode B, and access point (AP), which performs communication with the mobile station. In this specification, the base station may be used as a concept that includes a cell, sector, etc.

In a wireless communication system, a mobile station may receive information from a base station through a downlink (DL), and may also transmit information to the base station through an uplink. Examples of information transmitted from and received by the mobile station include data and various kinds of control information. Various physical channels exist depending on types and usage of information transmitted from or received by the mobile station.

The following technology may be used for various wireless access systems such as CDMA (code division multiple access), FDMA (frequency division multiple access), TDMA (time division multiple access), OFDMA (orthogonal frequency division multiple access), and SC-FDMA (single carrier frequency division multiple access). The CDMA may be implemented by the radio technology such as universal terrestrial radio access (UTRA) or CDMA2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802.20, and evolved UTRA (E-UTRA). The UTRA is a part of a universal mobile telecommunications system (UMTS). A 3rd generation partnership project long term evolution (3GPP LTE) communication system is a part of an evolved UMTS (E-UMTS) that uses E-UTRA, and uses OFDMA in a downlink while uses SC-FDMA in an uplink. LTE-advanced (LTE-A) is an evolved version of the 3GPP LTE system.

Although the following description will be based on the 3GPP LTE/LTE-A to clarify description of the present invention, it is to be understood that the technical spirits of the present invention is not limited to the 3GPP LTE/LTE-A. Also, specific terminologies hereinafter used in the embodiments of the present invention are provided to assist understanding of the present invention, and various modifications may be made in the specific terminologies within the range that they do not depart from technical spirits of the present invention.

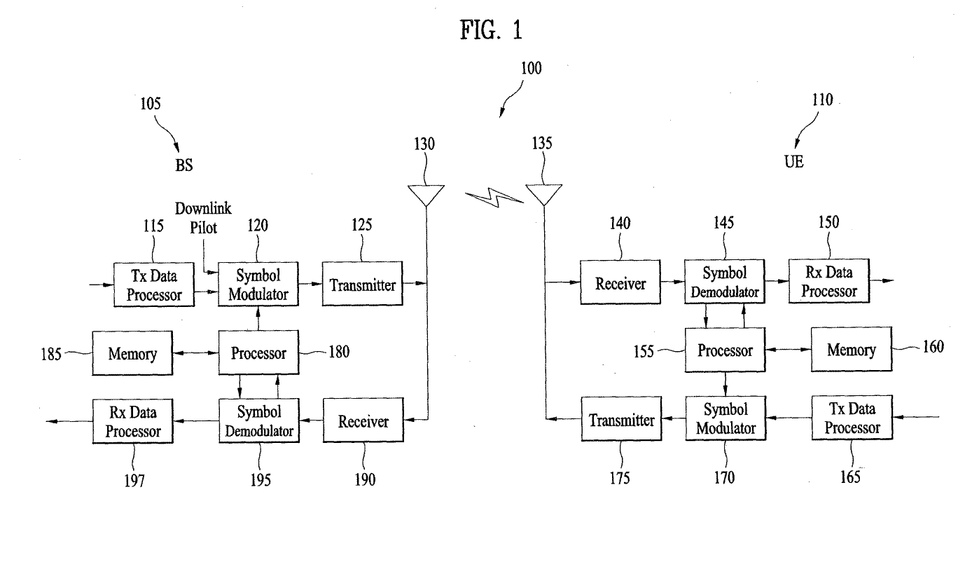

FIG. 1 is a block diagram illustrating configurations of a base station 105 and a mobile station 110 in a wireless communication system.

Although one base station 105, one mobile station 110 are shown for simplification of a wireless communication system 100, the wireless communication system 100 may include one or more base stations and/or one or more mobile stations.

Referring to FIG. 1, the base station 105 may include a transmitting (Tx) data processor 115, a symbol modulator 120, a transmitter 125, a transmitting and receiving antenna 130, a processor 180, a memory 185, a receiver 190, a symbol demodulator 195, and a receiving (Rx) data processor 297. The mobile station 110 may include a Tx data processor 165, a symbol modulator 170, a transmitter 175, a transmitting and receiving antenna 135, a processor 155, a memory 160, a receiver 140, a symbol demodulator 145, and an Rx data processor 150. Although the antennas 130 and 135 are respectively shown in the base station 105 and the mobile station 110, each of the base station 105 and the mobile station 110 includes a plurality of antennas. Accordingly, the base station 105 and the mobile station 110 according to the present invention support a multiple input multiple output (MIMO) system. Also, the base station 105 according to the present invention may support both a single user-MIMO (SU-MIMO) system and a multi user-MIMO (MU-MIMO) system.

On a downlink, the Tx data processor 115 receives traffic data, formats and codes the received traffic data, interleaves and modulates (or symbol maps) the coded traffic data, and provides the modulated symbols (“data symbols”). The symbol modulator 120 receives and processes the data symbols and pilot symbols and provides streams of the symbols.

The symbol modulator 120 multiplexes the data and pilot symbols and transmits the multiplexed data and pilot symbols to the transmitter 125. At this time, the respective transmitted symbols may be a signal value of null, the data symbols and the pilot symbols. In each symbol period, the pilot symbols may be transmitted continuously. The pilot symbols may be frequency division multiplexing (FDM) symbols, orthogonal frequency division multiplexing (OFDM) symbols, time division multiplexing (TDM) symbols, or code division multiplexing (CDM) symbols.

The transmitter 125 receives the streams of the symbols and converts the received streams into one or more analog symbols. Also, the transmitter 125 generates downlink signals suitable for transmission through a radio channel by additionally controlling (for example, amplifying, filtering and frequency upconverting) the analog signals. Subsequently, the downlink signals are transmitted to the mobile station through the antenna 130.

In the configuration of the mobile station 110, the antenna 135 receives the downlink signals from the base station 105 and provides the received signals to the receiver 140. The receiver 140 controls (for example, filters, amplifies and frequency downcoverts) the received signals and digitalizes the controlled signals to acquire samples. The symbol demodulator 145 demodulates the received pilot symbols and provides the demodulated pilot symbols to the processor 155 to perform channel estimation.

Also, the symbol demodulator 145 receives a frequency response estimation value for the downlink from the processor 155, acquires data symbol estimation values (estimation values of the transmitted data symbols) by performing data demodulation for the received data symbols, and provides the data symbol estimation values to the Rx data processor 150. The Rx data processor 50 demodulates (i.e., symbol de-mapping), deinterleaves, and decodes the data symbol estimation values to recover the transmitted traffic data.

Processing based on the symbol demodulator 145 and the Rx data processor 150 is complementary to processing based on the symbol demodulator 120 and the Tx data processor 115 at the base station 105.

On an uplink, the Tx data processor 165 of the mobile station 110 processes traffic data and provides data symbols. The symbol modulator 170 receives the data symbols, multiplexes the received data symbols with the pilot symbols, performs modulation for the multiplexed symbols, and provides the streams of the symbols to the transmitter 175. The transmitter 175 receives and processes the streams of the symbols and generates uplink signals. The uplink signals are transmitted to the base station 105 through the antenna 135.

The uplink signals are received in the base station 105 from the mobile station 110 through the antenna 130, and the receiver 190 processes the received uplink signals to acquire samples. Subsequently, the symbol demodulator 195 processes the samples and provides data symbol estimation values and the pilot symbols received for the uplink. The Rx data processor 197 recovers the traffic data transmitted from the mobile station 110 by processing the data symbol estimation values.

The processors 155 and 180 of the mobile station 110 and the base station 105 respectively command (for example, control, adjust, manage, etc.) the operation at the mobile station 110 and the base station 105. The processors 155 and 180 may respectively be connected with the memories 160 and 185 that store program codes and data. The memories 160 and 185 respectively connected to the processor 180 store operating system, application, and general files therein.

Each of the processors 155 and 180 may be referred to as a controller, a microcontroller, a microprocessor, and a microcomputer. Meanwhile, the processors 155 and 180 may be implemented by hardware, firmware, software, or their combination. If the embodiment of the present invention is implemented by hardware, application specific integrated circuits (ASICs), digital signal processors (DSPs), digital signal processing devices (DSPDs), programmable logic devices (PLDs), and field programmable gate arrays (FPGAs) configured to perform the embodiment of the present invention may be provided in the processors 155 and 180.

Meanwhile, if the embodiment according to the present invention is implemented by firmware or software, firmware or software may be configured to include a module, a procedure, or a function, which performs functions or operations of the present invention. Firmware or software configured to perform the present invention may be provided in the processors 155 and 180, or may be stored in the memories 160 and 185 and driven by the processors 155 and 180.

Layers, of a radio interface protocol between the mobile station 110 or the base station 105 and a wireless communication system (network) may be classified into a first layer L1, a second layer L2 and a third layer L3 on the basis of three lower layers of OSI (open system interconnection) standard model widely known in communication systems. A physical layer belongs to the first layer L1 and provides an information transfer service using a physical channel. A radio resource control (RRC) layer belongs to the third layer and provides control radio resources between the mobile station and the network. The mobile station and the base station may exchange RRC messages with each another through the RRC layer.

Throughout this specification, the processor 155 of the UE 110 and the processor 180 of the BS 105 perform an operation for processing signals and data except for a function of receiving or transmitting signals by the UE 110 and the BS 105 or a storing function. However, hereinafter, for convenience of description, the processors 155 and 180 will not be specially stated. Unless the processors 155 and 180 are not stated, a series of operations such as data processing but not the function of transmitting or receiving signals and the storing function may be performed.

Until now, such security/privacy aspects as authentication, security key setup, identifier management and the like have been led by a core network. The reason for this is that a communication paradigm has been configured with a network as the central figure. As mentioned in the foregoing description, since a user (or user equipment) centered communication paradigm will be realized in 5G wireless communication environment, the necessity for the technology capable of securing the protection of location information privacy of a user equipment increases more. In the present specification, by focusing on privacy of IMSI (international mobile subscriber identity) that is a user equipment identifier, a method for a user to perform an authentication procedure without exposing an identifier of the user will be disclosed.

As mentioned in the foregoing description, the privacy problem of a user identifier is a very important security issue to mobile communication users. Information on a permanent identifier (e.g., IMSI, etc.) enables malignant aggressors to obtain massive informations on an individual. If the malignant aggressors obtain informations on each individual user, it can be connected to various kinds of unexpected dangers. And, it may cause a big problem in using such sensitive services as online banking, shopping and the like through a user equipment.

LTE/LTE-A is a recent mobile communication system proposed by 3GPP and provides a security level further superior to that of a previous mobile communication system such as GSM, UMTS or the like.

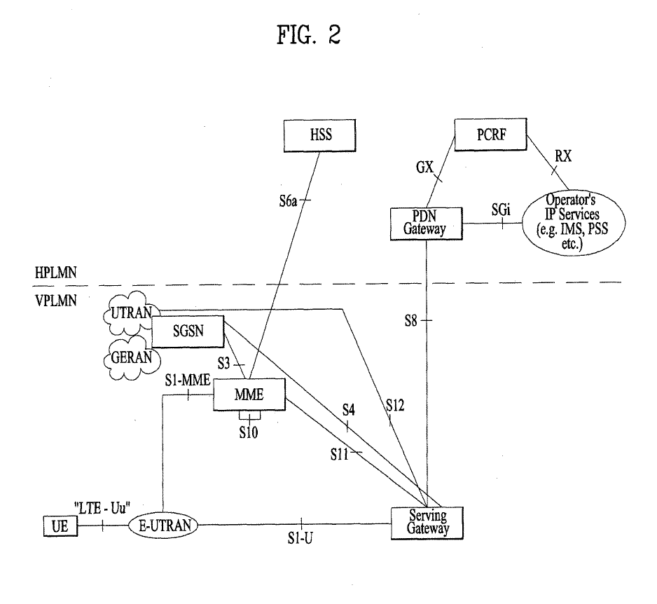

FIG. 2 is a diagram for one example of a roaming security architecture for a 3GPP network access.

Referring to FIG. 2, each user equipment (UE) has its subscription/profile information saved in a home subscriber server (HSS). And, the subscription/profile information of the corresponding user equipment is registered at a home public land mobile network (HPLMN). On a visited public land mobile network (VPLMN), the user equipment is connected to a base station through Uu interface for attach, tracking area update (TAU), service request or the like. A mobility management entity (MME) is a core control node for an LTE access network, plays a role in authenticating a user by interworking with the HSS, and is able to obtain authentication data of a user through the interworking with the HSS.

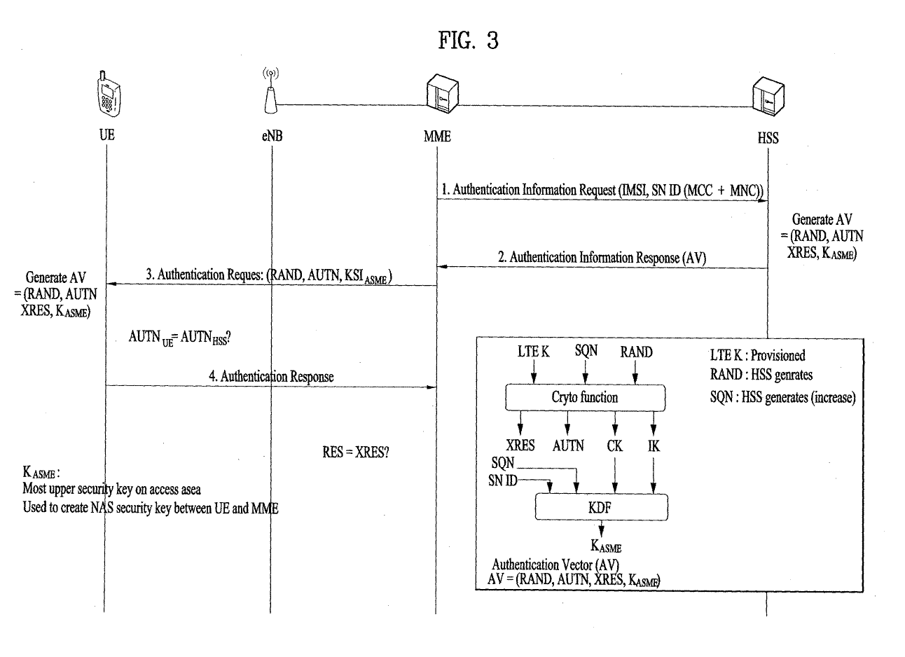

FIG. 3 is a diagram for one example of a procedure for an authentication data exchange between MME and HSS for user authentication.

A security relation of two layers is defined between a user equipment (UE) and a E-UTRAN or CN (core network). A first layer is described as an access stratum (AS), which protects RRC signaling between a user and a base station and UP (user plane) data. A second layer is described as a non-access stratum (NAS), which protect CP (control plane) signaling between a user and an MME.

EPS-AKA defined in 3GPP TS 33.401 is an authentication and key agreement procedure, through which key materials for extracting UP. RRC, NAC encryption keys and RRC, NAS integrity keys are generated. The EPS-AKA (evolved packet system authentication and key agreement) is basically performed when a user equipment attempts an initial access to a network.

Referring to FIG. 3, if an MME makes a request for authentication information (IMSI, SN ID (MCC+MNC)) to an HSS, the HSS generates EPS AV (authentication vector(s)) (RAND, AUTN, XRES, KASME) and then sends an authentication information response to the MME. The MME selects one of the authentication vectors, uses the selected authentication vector for mutual authentication with a user equipment, and shares the same authentication key (KASME) with the user equipment. In this case, the mutual authentication means a process for a network and a user equipment to authenticate each other. Since a serving network ID of a user equipment is required on an LTE network in generating an authentication vector, a user equipment performs authentication of a network as well as the network authenticates the user equipment.

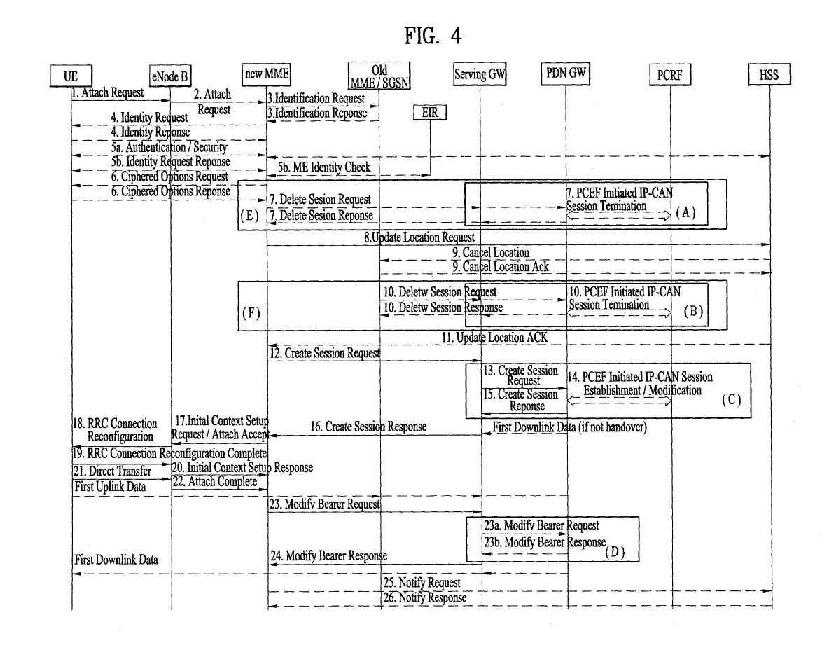

FIG. 4 is a diagram for one example of an initial access procedure of a user equipment (UE).

Referring to FIG. 4, in order to perform an initial authentication, a user equipment should perform an attach procedure. In doing so, an IMSI which is a permanent identifier of the user equipment is delivered without any protections (e.g., IMSI encryption, etc.) in a manner of being included in an attach request message delivered to an MME from the user equipment by RRC signaling. The reason for the IMSI corresponding to the permanent identifier of the user equipment is delivered through the attach request without any protections is that the user equipment does not have any temporary identifiers in case of an initial access.

In aspect of a network, if any entity fails to have a context for a corresponding user and authentication of the user equipment is successfully completed, the MME assigns a new temporary identifier called GUTI to the user equipment through an NAS. After the authentication procedure for the user equipment has been successfully completed, since NAS security is delivered after activation, the new GUTI can be safely delivered to the user equipment. After the new GUTI has been assigned to the user equipment, the MME manages information on a mapping relation between the IMSI of the user equipment and the GUTI assigned to the user equipment. The object of the GUTI assignment is to enable the MME to identify the user equipment without exposing the IMSI corresponding to the permanent identifier of the user equipment to OTA since the assignment of the GUTI. Namely, the identification of the user equipment for all connection setups (e.g., attach request, TAU, service request) through a radio path after the initial access is performed using GUTI instead of IMSI.

In order to secure privacy of IMSI that is a permanent identifier of a user equipment, confidentiality for the IMSI should be protected. This means that the IMSI should not be transmitted as a clear text to OTA. If IMSI is exposed, a malignant aggressor can obtain information such as a movement pattern of a corresponding user and the like.

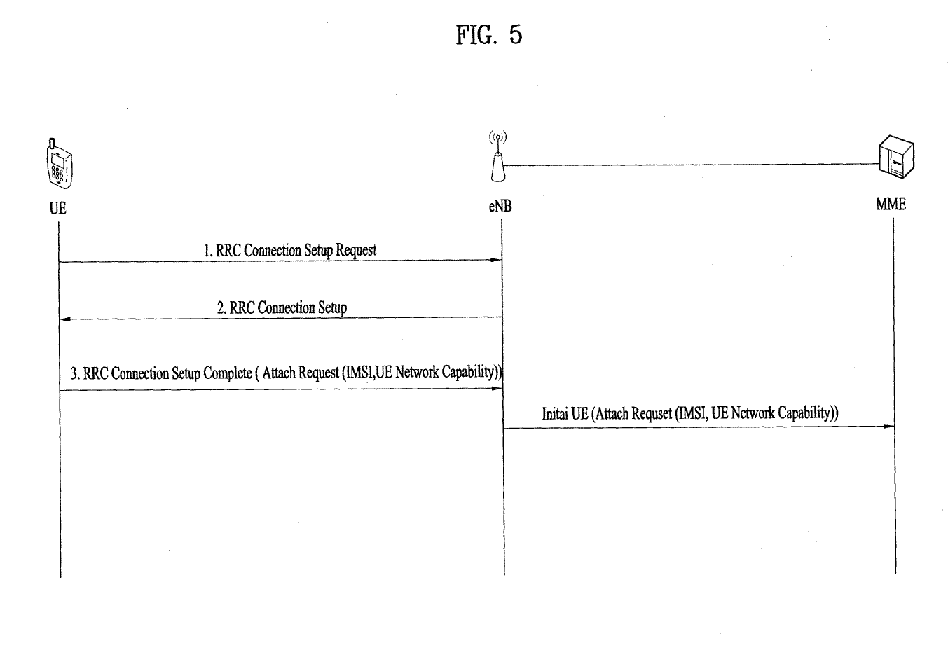

FIG. 5 is a diagram of a process for an RRC connection for a user equipment initial access and an attach request message delivery.

Referring to FIG. 5, for an initial access to LTE/LTE-A network, a user equipment (UE) sends an RRC connection setup request message for an EEC connection setup to a base station (eNB). If the base station (eNB) sends an RRC connection setup response message to the user equipment, the user equipment performs the RRC connection setup and then sends an RRC connection setup complete message indicating the completion of the RRC connection setup to the base station. In doing so, the user equipment also sends IMSI of the user equipment to the base station in a manner that the IMSI is contained in the RRC connection setup complete message without any protections. When the base station makes an attach request to an MME, the base station forwards the IMSI to the MME without any protections as it is.

LTE/LTE-A network employs security arrangement such as GUTI usable as a substitute for of IMSI. Yet, for the following cases, IMSI instead of GUTI can be transmitted to OTA.

(1) As mentioned in the foregoing description with reference to FIG. 5, when an attach procedure for an initial network access of a user equipment on LTE/LTE-A network is performed, a case that IMSI is transmitted without any protections

(2) When a serving network is unable to reason IMSI with GUTI used to identify a user equipment itself through a radio path on LTE/LTE-A network, a case that the user equipment transmits IMSI without any protections

(3) After a user equipment has moved into an area of a new MME on LTE/LTE-A network, if the new MME is unable to obtain IMSI from a previous MME, a case that the user equipment transmits IMSI without any protections

(4) As signals of a normal base station are drowned by a signal of a fake base station on LTE/LTE-A network, if IMSI is requested to a user equipment, a case that the user equipment transmits IMSI without any protections

Hence, required is a method for coping with a situation that a permanent identifier of a user equipment is exposed, which may occur in one of the above-listed cases in LTE/LTE-A system. Hence, the present invention proposes a method of solving a problem that a permanent identifier of a user equipment is transmitted to OTA without any protections in 5G wireless communication environment. The method proposed by the present invention follows an assumption that information on IMSI exists in a USIM of a user equipment and an HSS only like a related art LTE/LTE-A system, which means that the proposed method secures end-to-end identifier privacy for user equipments. According to the proposed method, a user equipment creates an identifier named Pseudo IMSI and then transmits the created identifier instead of IMSI to a network. Examples of generating Pseudo IMSI in the proposed method are described as follows.

1) Pseudo IMSI=f(IMSI, (truncate: Leftmost 15 bits) K)

2) Pseudo IMSI=f(IMSI, (truncate: Rightmost 15 bits) K)

3) Pseudo IMSI=f(IMSI, (truncate: Leftmost 15 bits) K, (truncate: Leftmost 15 bits) randomValue)

4) Pseudo IMSI=f(IMSI, (truncate: Leftmost 15 bits) K, (truncate: Rightmost 15 bits) randomValue)

5) Pseudo IMSI=f(IMSI, (truncate: Rightmost 15 bits) K, (truncate: Rightmost 15 bits) randomValue)

6) Pseudo IMSI=f(IMSI, (truncate: Rightmost 15 bits) K, (truncate: Leftmost 15 bits) randomValue)

As one example of the function F used by the 6 above-listed methods, it is able to consider a simple Bitwise XOR operation. In this case, the IMSI is the value having a maximum length of 15 bits and is configured with PLMN ID (MCC (3 bit)+MNC (2˜3 bit))+MSIN (9˜10 bit). The Long Term Shared Key K is a master key having a length of 128 bits. And, the RandomValue is 40-bit length value used on behalf of S-TMSI (40 bits) in RRC Connection Request message before assigning GUTI.

A user equipment may generate Pseudo IMSI by the function F using the IMSI and a portion of the K value [Method 1), Method 2)]. Alternatively, a user equipment may generate Pseudo IMSI by the function F using the IMSI, a portion of the K value and a portion of the randomValue [Method 3), Method 4), Method 5), Method 6)]. Thus, if the Pseudo IMSI is configured, since the IMSI and the Long Term Shared Key K are the values retained by the UE and the HSS only, it is able to prevent the IMSI from being exposed using the information shared between the user equipment and the HSS without sending the IMSI as Cleartext.

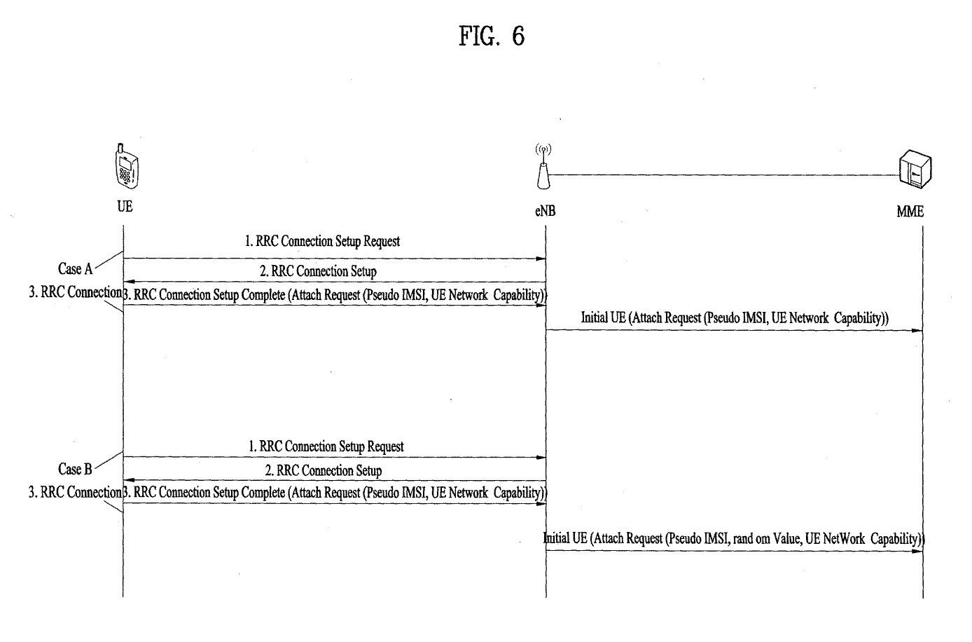

Yet, in case of considering the Pseudo IMSI in Method 3), Method 4), Method 5), or Method 6), the base station should forward the randomValue used at the AS end by the user equipment to the HSS via the MME. FIG. 6 shows a procedure as follows. First of all, a user equipment performs an RRC connection setup with a base station using the Pseudo IMSI proposed by the present invention. Secondly, the Pseudo IMSI for user identification is forwarded to an MME.

FIG. 6 is a diagram of a process for a user equipment (UE) to perform an RRC connection setup.

The contents of Method 1) and Method 2) among the Pseudo IMSI generating methods may apply to the procedure Case A shown in FIG. 6. On the other hand, the contents of Methods 3) to 6) among the Pseudo IMSI generating methods may apply to the procedure Case B shown in FIG. 6.

In the procedure Case A, if an MME receives Pseudo IMSI from a user equipment through a base station (eNB), the MME can reconstruct IMSI through Bitwise XOR operation with a value resulting from truncating Long Term Shared Key retained by the user equipment in accordance with a method for the user equipment to generate the Pseudo IMSI. In the procedure Case B, the MME can reconstruct an IMSI value for the user equipment by performing Bitwise XOR operation through a value resulting from truncating randomValue additionally received from the base station as well as the value resulting from truncating the Long Term Shared Key retained by the MME. As mentioned in the foregoing description, the randomValue is a 40-bit length value used instead of S-TMSI (40 bit) for user equipment identification in an RRC connection request message before assigning GUTI.

According to the present invention, described is a method of using IMSI and Long Term Shared Secret Key shared between USIM installed on a user equipment and an HSS for the privacy protection of a permanent identifier in case of an initial access of the user equipment. The USIM based communication is estimated as maintained in 5G wireless communication environment in the future and is also estimated as further including user's context or other additional functions as well as a user identifier.

According to an embodiment of the present invention, it is advantageous in that privacy of an end-to-end user identifier can be protected. In particular, without exposing ISMI to OTA, IMSI identification becomes possible between a user and an HSS only. And, it is also advantageous in easy portability. Without considering an excessive operation to generate Pseudo IMSI, the easy portability is enhanced in a manner that a user equipment and an HSS employ minor modifications for the Pseudo IMSI generation and dismantlement.

According to the method proposed by the present invention, it is advantageous in that an additional temporary identifier needs not to be assigned to hide an actual ID of a user equipment from a network in a step of an RRC connection between the user equipment and the network (e.g., a base station, etc.). Accordingly, according to the method proposed by the present invention, after an authentication procedure with a user equipment, it is unnecessary for a network to download STID, which is to be used safely by the user equipment, to the user equipment. And, according to the proposed method, it is advantageous in that a user equipment does not need to make and use an additional seed to create a virtual ID. In case of IEEE 802.16m system, a network can reason an actual ID of a user equipment only after receiving an additional seed from the user equipment through an authentication procedure. Yet, according to a method proposed by the present invention, it is advantageous in that a network can easily reason an actual ID from a virtual ID and is then able to use the actual ID for authentication and key creation without receiving an additional seed from a user equipment.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

Embodiments of the present invention can be implemented using various means. For instance, embodiments of the present invention can be implemented using hardware, firmware, software and/or any combinations thereof. In case of the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

A method for a user equipment to perform an initial access on a network by protecting privacy is industrially applicable to various kinds of wireless communication systems such as 3GPP LTE-A and the like.

1. A method of performing an initial access by a user equipment in a network by protecting privacy, the method comprising:
performing an RRC (radio resource control) connection setup with the network,
wherein the performing of the RRC connection setup comprising generating a pseudo permanent identifier for a permanent identifier of the user equipment and transmitting an RRC connection setup complete message including the pseudo permanent identifier to the network.

2. The method of claim 1, wherein the permanent identifier of the user equipment comprises IMSI (international mobile subscriber identity).

3. The method of claim 1, wherein the pseudo permanent identifier is generated using a bitwise XOR operation with the permanent identifier of the user equipment and a partial value of a long term shared key value shared by the user equipment and a home subscriber server (HSS).

4. The method of claim 1, wherein the performing of the RRC connection setup further comprises transmitting an RRC connection setup request message to the network and wherein the pseudo permanent identifier is generated using a bitwise XOR operation with the permanent identifier of the user equipment, a partial value of a long term shared key value shared by the user equipment and a home subscriber server (HSS) and a random value used for identification of the user equipment in the RRC connection request message.

5. The method of claim 4, wherein the random value comprises a 40-bit length value and wherein the long term shared key value comprises a 128-bit length value.

6. A user equipment for performing an initial access in a network by protecting privacy, a user equipment comprising:
a transmitter; and
a processor for performing an RRC (radio resource control) connection setup with the network,
wherein in performing the RRC connection setup, the processor generates a pseudo permanent identifier for a permanent identifier of the user equipment and
wherein the processor controls the transmitter to transmit an RRC connection setup complete message including the pseudo permanent identifier to the network.

7. The user equipment of claim 6, wherein the permanent identifier of the user equipment comprises IMSI (international mobile subscriber identity).

8. The user equipment of claim 6, wherein the processor generates the pseudo permanent identifier using a bitwise XOR operation with the permanent identifier of the user equipment and a partial value of a long term shared key value shared by the user equipment and a home subscriber server (HSS).

9. The user equipment of claim 6, wherein in performing the RRC connection setup, the transmitter transmits an RRC connection setup request message to the network and wherein the processor generates the pseudo permanent identifier using a bitwise XOR operation with the permanent identifier of the user equipment, a partial value of a long term shared key value shared by the user equipment and a home subscriber server (HSS) and a random value used for identification of the user equipment in the RRC connection request message.

10. The user equipment of claim 9, wherein the random value comprises a 40-bit length value and wherein the long term shared key value comprises a 128-bit length value.
